(19) United States
(12) Patent Application Publication
(10) Pub. No.: US 2020/0053573 A1
(43) Pub. Date: Feb. 13, 2020

(54) PRIORITY AND LOCKING MECHANISM FOR NETWORK MODULES

(71) Applicant: Nokia Solutions and Networks Oy, Espoo (FI)

(72) Inventors: Rekha Menon, Bothell, WA (US); Eamonn Gormley, Bothell, WA (US); Christophe Vidal, Bothell, WA (US); Dave Hurchalla, Bothell, WA (US)

(21) Appl. No.: 16/604,172

(22) PCT Filed: Apr. 18, 2017
(86) PCT No.: PCT/US2017/028095

§ 371 Date: Oct. 10, 2019

(51) Int. Cl. H04W 16/18; H04W 40/24; H04W 24/02; H04W 84/18

(52) U.S. Cl. CPC H04W 16/18; H04W 84/18; H04W 24/02; H04W 40/24

(57) ABSTRACT

A method for coordinating execution of functions within a self-organizing network is disclosed, the network including a plurality of network parameters, a controller, a locking mechanism having a processor and a memory and being in communication with the controller, and a plurality of modules configured for operating on the network parameters, wherein each of the plurality of modules is assigned a corresponding priority. The method includes receiving a request from at least one of the modules for a lock, and providing the lock to the module having a highest priority level relative to the plurality of modules that requested a lock. The method further includes receiving a request at the locking mechanism from the module having the lock, and enabling the module having the lock to make changes to a network parameter of the plurality of network parameters, wherein the changes include at least one of steady-state changes, transient changes, and provisional changes.

### FIELD OF TECHNOLOGY

This disclosure relates generally to the field of self-organizing networks (SON), and more particularly to locking mechanisms configured to coordinate the execution of different SON functions within the SON.

### BACKGROUND

SON products are adapted to provide different functionalities to configure, optimize, and heal SON cellular networks. Current SON systems include SON modules, which are configured to operate on objects within the network. For example, the SON modules can be configured to operate on any parameter or node in the SON system, such as a network node, a cell, and a radio network controller (RNC).

SON modules may be classified into two categories, based on the type(s) of scenarios which they address: Event Response (ER) Modules; and Network Improvement (NI) Modules. ER Modules are generally used to address a specific network event or short-term network fluctuation. NI Modules are typically used to improve baseline network performance.

As a result of SON module operation on managed objects or parameters within the network, the network may experience changes. Managed objects can represent, for example, a base station, a cell, or a neighbor relation. The SON module can be configured to operate on the managed objects themselves, or on parameters of the managed objects. For the purpose of this disclosure, the term “object” can be used to identify a managed object or a parameter associated with the managed object. SON Modules may make three different types of object changes: Steady-state changes, Transient changes, and Provisional changes. Steady-state changes are typically long-term changes to the network objects that can improve the network's baseline performance, and are generally pushed by NI Modules. An example of a steady-state change is an antenna-tilt change pushed by a Coverage & Capacity Optimization (CCO) SON Module. Transient changes, on the other hand, are short-term changes to network objects that are pushed by modules to address network fluctuations and short-term events. Transient changes are rolled-back to restore the objects to their values prior to the transient change, after the module finishes its current operation on the object. An example of a transient change is a Handover (HO) parameter change pushed by a Mobility Load Balancing (also an NI Module) module in response to congestion. When the congestion recedes, the HO parameter is restored to the value it was set to prior to the transient change. Finally, provisional changes are transient changes to objects that may be made steady-state after the performance impact of the changes are evaluated by a verification function.

The various SON Modules in the SON system may request to operate on objects in the network at the same time or in such a manner that the network needs to determine the priority in which the modules can function. In order to arbitrate changes from multiple modules, priority and locking mechanisms (PLM) have been developed for SON and other network management systems. However, existing PLM are not able to fully address how roll-back of changes are handled after the various modules have concluded their operations. Further, existing PLM are not able to address how roll-back of changes are handled when module operation on an object is pre-empted because the object is already being operated on by a higher priority module. There also does not currently exist a common framework to handle the above-identified and additional issues, which will be described in detail further below.

### SUMMARY

A method for coordinating execution of functions within a self-organizing network is disclosed, the network including a plurality of network parameters, a controller, a locking mechanism having a processor and a memory and being in communication with the controller, and a plurality of modules configured for operating on the network parameters, where each of the plurality of modules is assigned a corresponding priority. The method includes receiving a request from at least one of the modules for a lock, and providing the lock to the module having a highest priority level relative to the plurality of modules that requested a lock. The method further includes receiving a request at the locking mechanism from the module having the lock, and enabling the module having the lock to make changes to a network parameter of the plurality of network parameters, wherein the changes include at least one of steady-state changes, transient changes, and provisional changes. The method also includes releasing the lock on the enabled module when the enabled module has completed its operation on the network parameter.

A locking mechanism is provided in a communications network including a plurality of network parameters and a plurality of modules configured for operating on the network parameters, where each of the plurality of modules is assigned a corresponding priority. The locking mechanism includes a processor and a memory. The locking mechanism is configured to detect that at least one module of the plurality of modules has attempted to initiate a change to a network parameter, and provide a lock to the highest priority detected module that has attempted to initiate a change to a network parameter. The locking mechanism is further configured to enable the highest priority detected module to make changes to the network parameter, wherein the changes include at least one of steady-state changes, transient changes, and provisional changes. The locking mechanism is also configured to release the lock on the enabled module when the locking mechanism has determined that the enabled module has completed its operation on the network parameter.

A system includes a SON controller, a plurality of network parameters configured for operating within the system, a module engine including a plurality of modules, and a locking mechanism configured for managing the plurality of modules. The module engine and the locking mechanism can be provided within the SON controller. The locking mechanism is configured to arrange the modules based on a priority level, provide a lock to the module requesting the lock having a highest priority level relative to the plurality of modules requesting the lock. The locking mechanism is further configured to enable the requesting module having the highest priority level to operate on a network parameter of the plurality of network parameters, and monitor changes made to the network parameter by the enabled module, wherein the changes include at least one of steady-state changes, transient changes, and provisional changes. The locking mechanism is also configured to release the lock on the enabled module when the locking mechanism has determined that the enabled module has completed its operation on the network parameter, and roll back the transient changes made to the network parameter by the enabled module.

### DESCRIPTION OF THE SEVERAL VIEWS OF THE DRAWINGS

To aid in the proper understanding of the present disclosure, reference should be made to the accompanying drawings, wherein:

FIG. 1 illustrates a prior art priority and locking mechanism (PLM);

FIG. 2 is a diagram of an enhanced priority and locking mechanism (ePLM) in accordance with an embodiment of the present disclosure;

FIG. 3 is a diagram of a system in accordance with an embodiment of the present disclosure;

FIG. 4 is a flow chart of a method in accordance with an embodiment of the present disclosure;

FIG. 5 is a flow diagram illustrating how lock states can be handled in accordance with an embodiment of the present disclosure;

FIG. 6 is a flow chart of a method for handling transient changes in accordance with an embodiment of the present disclosure;

FIG. 7 is a flow chart of a method for handling steady state changes in accordance with an embodiment of the present disclosure;

FIG. 8 is a signaling diagram of how the locking mechanism can handle transient and steady state changes, in accordance with an embodiment of the present disclosure;

FIG. 9 is a flow chart of a method for handling provisional changes in accordance with an embodiment of the present disclosure;

FIG. 10 is a signaling diagram of a verification process for provisional changes, in accordance with the present disclosure;

FIG. 11 is a signaling diagram for handling coupled changes, in accordance with an embodiment of the present application; and

FIG. 12 is a signaling diagram for rolling back coupled changes, in accordance with an embodiment of the present disclosure.

### DETAILED DESCRIPTION

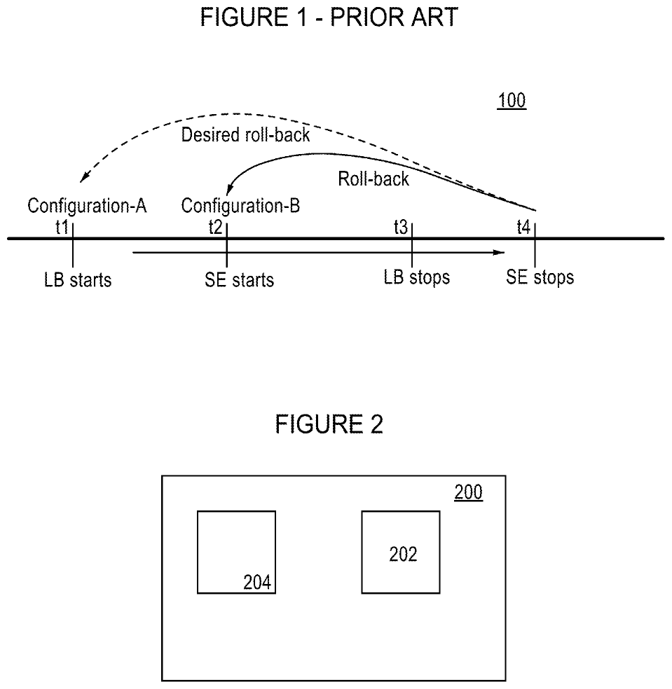

Referring to FIG. 1, a prior known Priority and Locking Mechanism (PLM) flow diagram 100 is illustrated. In this scenario, a cell-1 initially starts with Configuration-A. As congestion develops in the cell at time t1, a Load Balancing (LB) module is executed on the cell to address the congestion event, changing cell-1's configuration to Configuration-B. At time t2, a Special Events (SE) module with higher priority than the LB module is executed on the cell-1. However, when the SE starts execution on cell-1 at time t2, cell-1's configuration has already been changed by the LB module to Configuration-B. Since the SE module has a higher priority than the LB module, the SE module pre-empts further changes by the LB module on cell-1. At time t3, the LB module completes its operation on cell-1, and rolls-back all of its changes except those changes made to cell-1. At time t4, the SE module completes its operation on cell-1, and rolls back its changes made to cell-1 such that cell-1 reverts back to Configuration-B (i.e., the configuration of cell-1 when the SE module began its operation on the cell). However, Configuration-B has residual transient changes that were pushed by the LB module, which has since completed its operation. The SE module should have rolled back the configuration of the cell-1 to Configuration-A, but was unable to do so because current PLMs are not able to accurately handle roll-back of changes when one module is pre-empted by a higher priority module.

To address the above and other issues with existing PLMs, an enhanced Locking and Priority Mechanism (ePLM) 200 is provided in the present disclosure, as seen in FIG. 2. Broadly speaking, the ePLM or locking mechanism 200 is configured to enable modules to operate on objects in the order of their priority. The ePLM 200 accomplishes this by providing locks to modules that wish to operate on an object in the network, and by only allowing the module to operate on the object if the module has the highest priority among the modules that have a lock on the object. The ePLM 200 is further configured to track transient changes applied by a module, such that the ePLM can automatically roll-back the module's transient changes at the conclusion of the module's operation. This and other functions of the ePLM 200 will be further described in detail below.

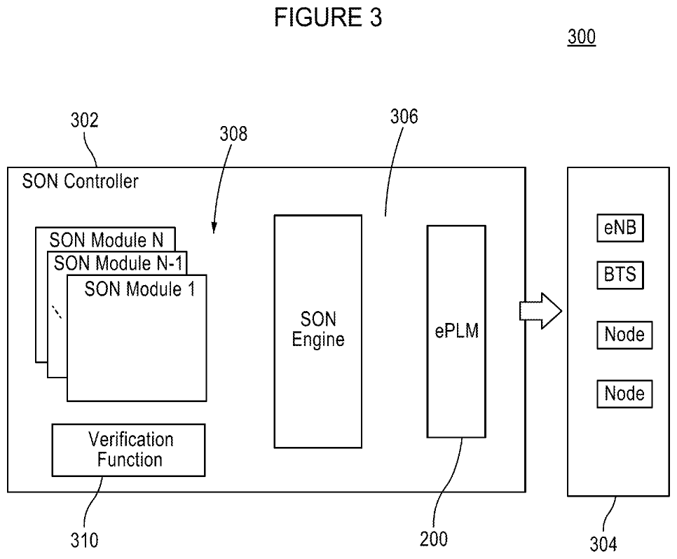

Referring to FIG. 2, the ePLM or locking mechanism 200 is provided within a communications network 300 (see FIG. 3) and can include a processor 202 and a memory 204. Via the processor 202, the ePLM 200 is configured to perform methods in accordance with the present disclosure, each of which will be described in further detail below. The ePLM 200 can be a standalone component within the network 300, or it can be provided within a network controller, for example. As will be described with further detail below, the locking mechanism 200 is configured to arrange the modules based on a priority level, and to provide a lock to the module requesting the lock that has the highest priority level relative to the plurality of modules requesting the lock. The ePLM 200 is further configured to receive a request from the module having the highest priority level and to enable the module having the highest priority level to operate on a network parameter of the plurality of network parameters. In addition, the ePLM 200 can monitor changes made to the network parameter by the enabled module, and release the lock on the enabled module when the locking mechanism has determined that the enabled module has completed its operation on the network parameter

As seen in FIG. 3, in the present disclosure, the ePLM 200 can be part of the communication network 300, which can include a SON controller 302 that can be centrally located within the network 300 and configured to communicate with the network. Although not shown, the SON controller 302 can also be a distributed controller, such that each cell within the network has its own SON controller, rather than a centralized controller configured to manage each cell. The SON controller 302 is further configured to communicate with the ePLM 200, which can be located within the SON controller.

The network 300 further includes a plurality of managed objects or network parameters 304 (also referred to as objects) configured for operating within the network. For example, and as will be described in further detail below, the ePLM 200 can provide a lock to a requesting module to operate on an object. The object 304 can include at least one of a network node or element, an eNB in the network, and a base station in the network, although the objects are not limited to the above list.

For example, consider UMTS, which has the following nodes in hierarchical order: RNC, WBTS, and WCEL. In accordance with one embodiment of the present disclosure, if a module requests a lock to operate on the RNC, the lock provided by the ePLM 200 would also imply a lock on the WBTS and WCEL. This is because network parameters are generally hierarchical in structure. As such, the network parameters 304 can include any parameter at the lowest level or any node in the hierarchy. However, if a module requests a lock to operate on the WCEL, which is the lowest-ranked in the node hierarchy, the lock may not include the higher ranked nodes (i.e., the WBTS and the RNC). In other words, if the module wishes to operate on the WBTS, it would request a new lock from the ePLM 200. In another embodiment of the present disclosure, if one module wishes to acquire a lock on a managed object, such as a base station, it locks all of the network parameters associated with the managed object.

The network 300 further includes a module engine 306 that is configured to manage the operations of a plurality of (SON) modules 308, and a verification function 310. Each of the module engine 306, the SON modules 308, and the verification function 310, can be located within the SON controller 302. In an alternative configuration (not shown), the module engine 306 can include the locking mechanism or ePLM 200, which is configured for managing the plurality of modules 308. As described above, the modules 308 can be classified into two categories: Event Response (ER) Modules, and Network Improvement (NI) Modules. ER Modules are used to address specific network events and/or short-term network fluctuations. At the end of the network event or fluctuation, changes made by the ER Modules are typically rolled back, which will be described in further detail below. In other words, after the ER Module has completed its operation on a respective object, the ePLM 200 is configured to return the object back to its original configuration. ER Modules are generally assigned a higher priority than NI Modules. NI Modules are used to improve the baseline performance of the network 300. Changes made by the NI Modules on respective network parameters are typically retained, even after the NI Module has finished its operation. NI Modules are generally assigned lower priorities than ER Modules.

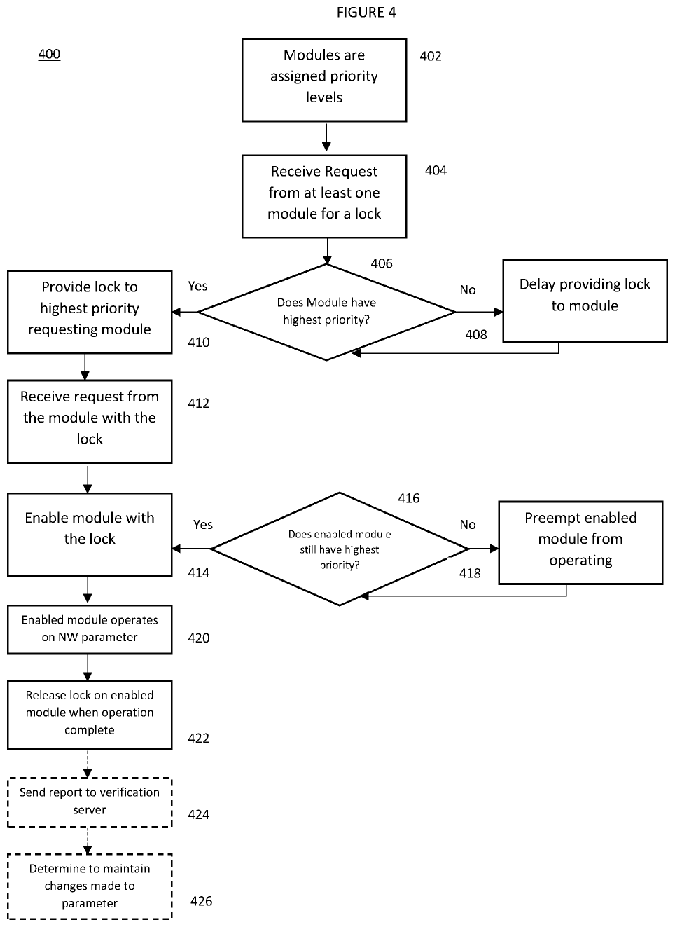

FIG. 4 illustrates a method 400 in accordance with the present disclosure. At 402, the modules are assigned priority levels. The locking mechanism or ePLM 200 is aware of these assigned priority levels and can use this knowledge to determine whether the module requesting the lock has the highest priority level out of the other modules that may have requested a lock. For example, if the SON 300 includes an ER Module, such as a Cell Outage Compensation (COC) Module, and an NI Module, such as an Automatic Neighbor Relation (ANR) Module, the Cell Outage Compensation Module will be assigned the higher priority, and the ANR Module will be assigned with a lower priority. If two or more modules have the same priority level, then the ePLM 200 is configured to provide the lock to the module with the earliest time-stamped request for a lock.

At 404, the ePLM 200 receives a request from at least one of the modules for a lock to operate on one of the network parameters in the SON 300. Alternatively, the ePLM 200 can be configured to detect that at least one of the modules has attempted to operate on a network parameter in the SON 300. At 406, the ePLM 200 determines whether the current requesting module has the highest priority out of the requesting modules. In other words, if both the ANR Module and the COC Module request the lock to operate on a network parameter, then the ePLM 200 will provide the lock to the COC Module, because it has the highest priority of the requesting modules. If the requesting module does not have the highest priority out of all of the requesting modules, the ePLM 200 can delay providing the lock to the ANR Module at 408, because it is the lower priority of the requesting modules. The ePLM 200 can optionally store the request from the lower priority module in memory 204 or an external database, for example. Similarly, if a lower priority module requests a lock after a lock has already been provided to a higher priority module, the ePLM 200 can delay providing the lock to the lower priority module until the higher priority module with the lock has completed its operation. The lower priority module can then be provided with a lock, assuming that the lower priority module is now the highest priority module that has requested a lock.

If the requesting module is the highest priority module out of all of the requesting modules (i.e., if the requesting module is the COC Module, for example), then the ePLM 200 provides the lock to the module at 410. At 412, the ePLM 200 receives a request from the module having the lock, i.e., the COC Module. The request indicates to the ePLM 200 that the COC Module wishes to perform operations to a corresponding network parameter. At 414, the ePLM 200 enables the COC module to make changes to the network parameter.

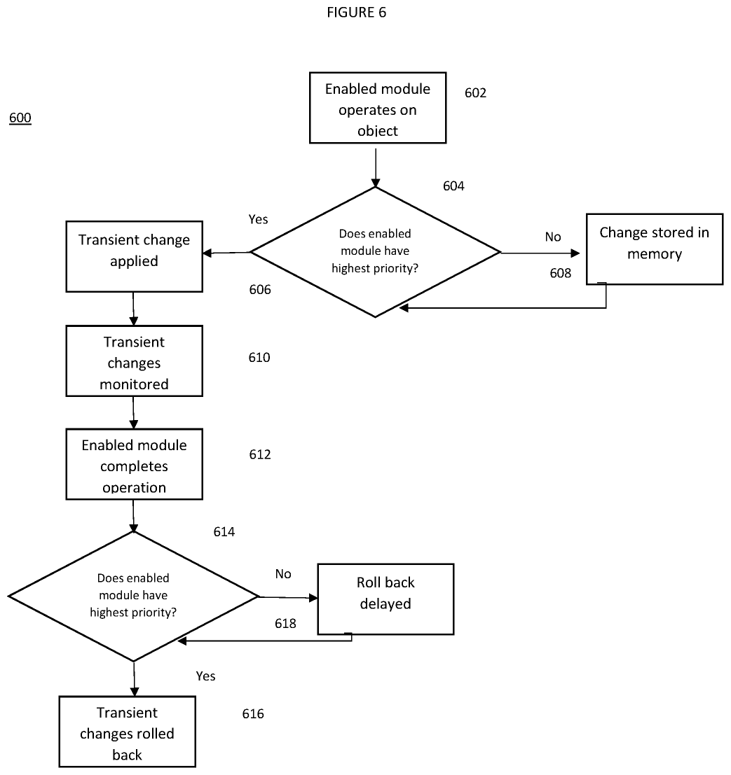

As described above, the changes include at least one of steady-state changes, transient changes, and provisional changes. Steady-state changes are long-term changes to the network that improve the baseline performance of the network, and are not rolled-back after the module finishes its operation on the network parameter. Transient changes, on the other hand, are short-term changes pushed by enabled modules to address network fluctuations and short-term events. As will be described in further detail below with respect to FIGS. 6-8, transient changes are rolled-back after a module finishes its operation on a network parameter, to return the network parameter back to its original (or pre-operational change) configuration. Finally, provisional changes are transient changes pushed by enabled modules, which may become steady-state after the performance impact of the changes is evaluated by the verification function. If the verification function determines that the performance impact of the changes is negative, then it can convert the provisional change to a transient change, enabling the changes to the parameter to be rolled back.

At 416, the ePLM 200 can check to make sure that the enabled module still has the highest priority. In other words, if a module having a higher priority (Module A) than the currently enabled COC Module requests a lock from the ePLM 200 during this method 400, the ePLM 200 can preempt the enabled COC Module from operating on the network parameter at 418, so that Module A can be given the lock on the parameter and enabled to operate on the network parameter. While the COC Module is preempted, the ePLM 200 can be configured to store an attempted change value of the network parameter based on the operation completed by the COC Module. In other words, and as will be described in further detail below, in one embodiment, while the COC Module is preempted, the changes it attempted to make to the network parameter can be stored in a ChangeStore or similar database. After preemption, the ePLM 200 can take the stored change value and allow the change to be made to the network parameter.

The enabled module (in this example, Module A) is therefore enabled to operate on the network parameter at 420. When Module A finishes its operation on the network parameter, the ePLM 200 can release the lock on Module A at 422. The ePLM 200 can be configured to restore the change value of the network parameter based on the operation completed by the COC Module (i.e., the ePLM 200 can make the change to the parameter based on the changes made by the COC Module prior to its preemption), and the pre-empted COC Module can again be enabled at 414 and allowed to operate on its respective network parameter at 420. At 422, when the COC Module has completed its operation on the network parameter, the ePLM 200 can release the lock on the COC Module. The COC Module can alert the ePLM 200 that it has completed its operation, or alternatively, the ePLM can detect that the COC Module has completed its operation on the network parameter. The method 400 will then repeat itself such that the ePLM 200 will provide a lock to the next highest module that has requested a lock to operate on a network parameter.

As optionally shown in FIG. 4, the method 400 can further include, at 424, sending a report of the changes made to the network parameter to a verification server in the network. At 426, the verification server can be configured to determine whether to maintain the changes made to the network parameter.

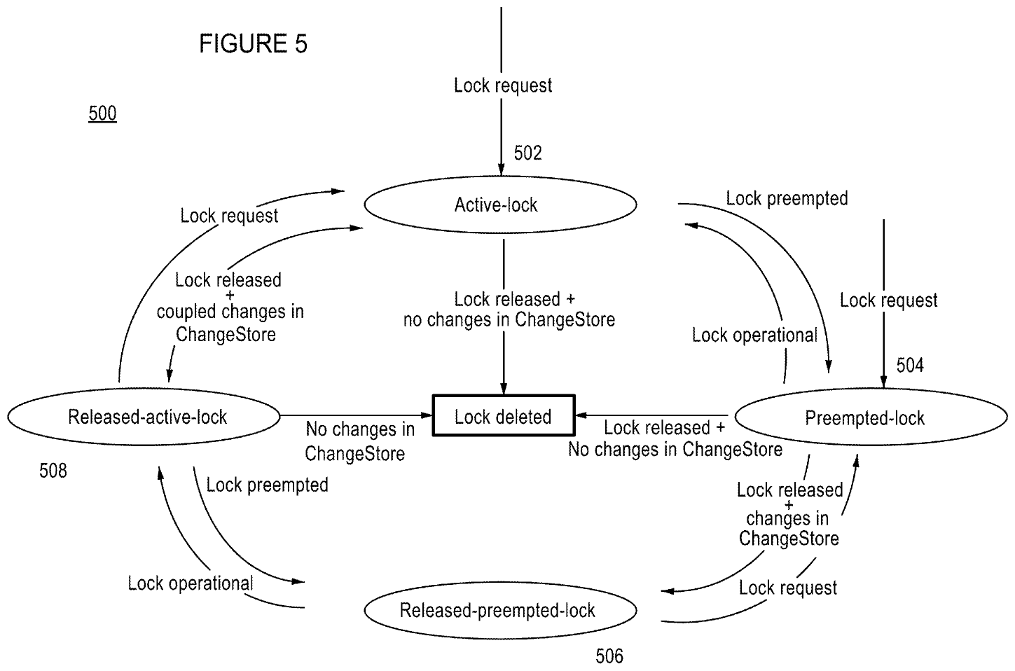

FIG. 5 illustrates a flow diagram of lock states 500 from the point of view of the ePLM 200, and in accordance with the present disclosure. The ePLM 200 uses lock states to keep track of requests made by the modules to operate on an object. As described above, the ePLM 200 is configured to provide a lock to a requesting module when the module wishes to operate on a network parameter. If the requesting module has the highest priority out of the modules requesting a lock, the requesting module is given an “Active-lock” (or is given the lock, per the previous description and below details). If the requesting module does not have the highest priority out of the modules requesting a lock, the requesting module is provided with a “Preempted-lock”. The ePLM 200 keeps track of the lock states of the modules. Note that from the perspective of the modules, they either “have a lock” or “do not have a lock”. Instead of the module requesting a lock, in another embodiment, the ePLM 200 can automatically issue a lock to a module if it detects that the module has attempted to operate on a network parameter.

Each lock can be assigned a unique ID by the ePLM 200, which can be further configured to track the locks on different modules in a ChangeStore or other database in memory 204, for example. Once a lock is issued to a module, the lock is considered to be “Active” or “Preempted”, from the point of view of the ePLM 200. The ePLM 200 is configured to manage the lock states of the modules, ensuring that it is aware of when to make a lock active, preempt a lock, release a lock, etc. As can be seen from the Figure, the ePLM 200 is configured to manage four lock states: Active-lock (i.e., when a module receives a lock to operate on a module/object), Preempted-lock, Released-preempted lock, and Released-active-lock.

When a lock is requested by Module A, for example, the ePLM 200 determines whether to provide Module A with the lock, based on the module's priority relative to other modules that have requested a lock. If the Module A is provided with the lock and is enabled to operate on the desired network parameter, the lock is in an “Active-lock” state 502. In the Active-lock state, the lock is operational on the network parameter or object, and has not yet been released by its associated module or by the ePLM 200. Module A may operate on the network parameter to make changes while the lock is in the active-lock state.

While the lock for Module A is in the “Active-lock” state, it can be preempted if a Module B, with a higher priority than Module A, requests a lock to operate on a network parameter. If the lock on Module A is pre-empted so that the lock on Module B can be enabled and put into the “Active-lock” state, then the lock on Module A changes to a “Preempted-lock” state 504. The lock on Module A can be converted back into the active-lock state when Module B has finished its operation, assuming that there are no other pending lock requests from modules having a higher priority than Module A.

The lock on Module A can be converted to a “Released-preempted lock” state 506 if it has been released by Module A but is still being tracked by the ePLM 200. Further, the lock on Module A can be converted to a “Released-active-lock” state 508 when the lock has been released by Module A but Module A becomes operational on its respective network parameter. The modules can either explicitly request release of the lock, or the ePLM 200 can release the lock after detection that the operation on the network parameter has been completed or halted (due to pre-emption, for example). The lock, even in the release state, is still tracked by the ePLM 200 via the processor 202 and memory 204, or alternatively, through the external SON controller 302.

When the lock is in one of the above “release” states, the ePLM 200 is configured to determine if there are unapplied changes associated with the lock. For example, the ePLM 200 can check the lock's unique ID to determine if there are any unapplied changes associated with the lock. If there are no unapplied changes associated with the lock, the ePLM 200 rolls-back any transient changes and deletes the lock associated with the operational module (i.e., Module A). If there are unapplied transient changes associated with the lock, the ePLM 200 can remove the unapplied changes. Unapplied steady-state or provisional changes can be removed by the ePLM 200, or can be applied at a future time by the ePLM. Applied transient changes can be rolled-back, such that the network parameter is restored to its original configuration (or to its configuration prior to the operation by the module). The various changes and how they are applied will be discussed in further detail below with respect to FIGS. 6-10.

As discussed briefly above, the ePLM 200 is configured to manage network parameter changes made by the modules. There are three different changes recognized by the ePLM 200: Transient changes, steady-state changes, and provisional changes. FIG. 6 illustrates a method 600 for handling transient changes in accordance with the present disclosure. The ePLM 200 is configured to monitor transient changes made to the network parameter by the enabled module and roll back the transient changes made to the network parameter by the enabled module. Specifically, at 602, the enabled module, Module A, operates on an object or network parameter having an initial configuration. At 604, the ePLM 200 monitors whether the Module A has the highest priority lock on the network parameter. If Module A is the highest priority enabled module currently operating on the network parameter, then at 606, the ePLM 200 allows the transient change to be made to the network parameter. If Module A is not the highest priority enabled module currently operating on the network parameter, then at 608, the ePLM 200 stores the change in a database or in the memory 204 until Module A becomes the highest priority enabled module with an operational lock configured for making changes to the network parameter. At 610, the ePLM 200 keeps track of the transient changes that have been made to the network parameter, either in the ChangeStore database or in the memory 204, for example. At 612, Module A completes its operation on the network parameter.

As previously described, the ePLM 200 can detect that Module A has completed its operation, or Module A can alert the ePLM that it has completed its operation. The ePLM 200 can then roll back the transient changes made to the network parameter by Module A. Specifically, at 614, the ePLM 200 determines whether Module A is the highest priority module having a lock on the network parameter. If so, then at 616, the ePLM rolls back the transient changes made to the network parameter, such that the network parameter is restored to its initial configuration. If Module A is not the highest priority module having a lock on the network parameter, then at 618, the ePLM 200 delays the roll back of transient changes until Module A is the highest priority module having a lock on the network parameter.

In addition to rolling back transient changes based on the priority level of the enabled module attempting to change the network parameter, the ePLM 200 can roll back transient changes made by the highest priority module in a descending order of the times at which the changes were applied. For example, if Module A is the highest priority enabled module operating on the network parameter, and Module A made three transient changes to the network parameter, the transient change with the latest “Time-Applied” (as stored in the memory 204 or ChangeStore database) is rolled-back first, followed by the next latest “Time-Applied” transient change, and then ending with the most recent “Time-Applied”transient change. Once the transient changes are rolled back, they can be removed from the database/memory.

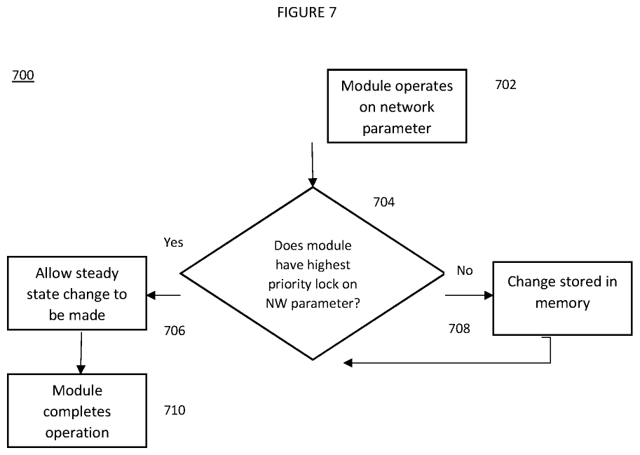

FIG. 7 illustrates a method 700 for handling a steady state change made to the network parameter by the enabled module, Module A. At 702, Module A operates on a network parameter having an initial configuration. At 704, the ePLM 200 monitors whether the Module A has the highest priority lock on the network parameter. If Module A is the highest priority enabled module currently operating on the network parameter, then at 706, the ePLM 200 allows the steady-state change to be made to the network parameter. If Module A is not the highest priority enabled module currently operating on the network parameter, then at 708, the ePLM 200 stores the change in a database or in the memory 204 until Module A becomes the highest priority enabled module with an operational lock configured for making changes to the network parameter. At 710, Module A completes its operation on the network parameter. As previously mentioned, the ePLM 200 can detect that Module A has completed its operation on the network parameter, or alternatively, Module A can alert the ePLM 200 that it has completed its operation. When a steady state change is applied in accordance with the method 700, the ePLM 200 will not roll back any transient changes made to the network parameter prior to the application of the steady state change. In other words, if a steady state change is made to the network parameter after a transient change is made to the same network parameter, the steady state change takes precedence, because any roll back of the transient change would also revert the steady state change.

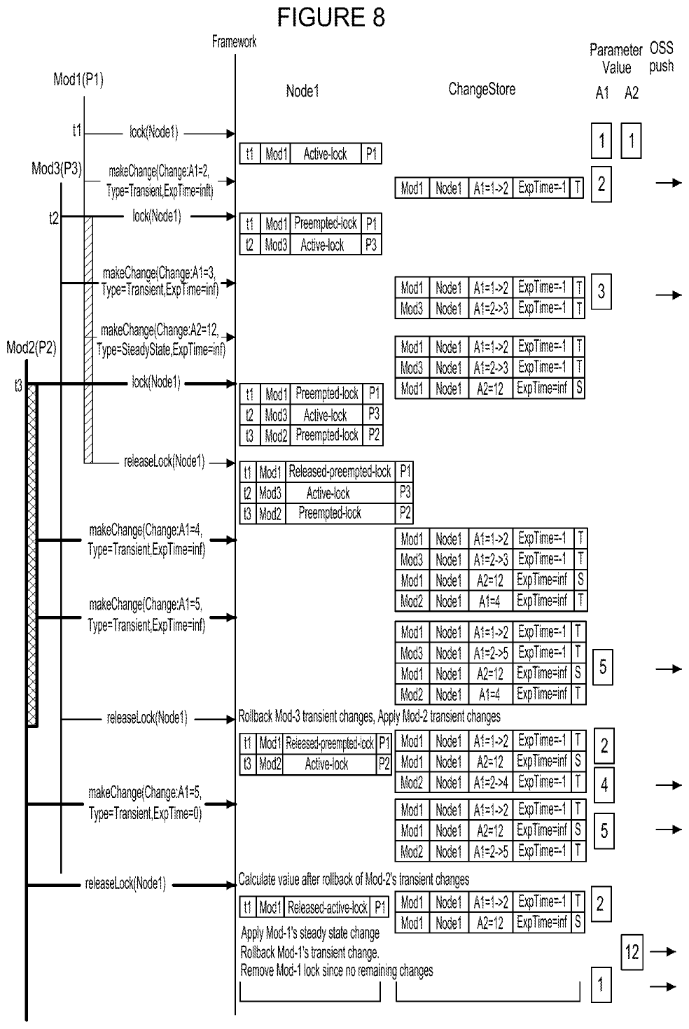

FIG. 8 provides an example signal/flow diagram 800 illustrating how transient and steady state changes can be handled by the ePLM 200. In accordance with diagram 800, there are three Modules: Module 1, Module 2, and Module 3. Module 1 has the lowest priority level, P1. Module 2 has the middle priority level, P2. Module 3 has the highest priority level, P3. In the present embodiment, at 802, Module 1 is provided with a lock and is initially operational on the object (in this example, Node 1), which has an initial parameter value of “1”. At 804, Module 1 pushes a transient change to Node 1, which is stored at 806 in the ChangeStore for potential rollback later in the operation. The transient changes is immediately applied by the ePLM 200, because Module 1 has an active-lock on Node 1. As such, at 808, the parameter value of Node 1 is changed to “2”.

At 810, the ePLM 200 preempts Module 1's operation on Node 1, because Module 3, which has a higher priority P3 than Module 1, has requested a lock and been provided with an active lock. At 812, Module 3 pushes a transient change to Node 1, which is stored in the ChangeStore. As can be seen in the Figure, Module 3 wishes to change the parameter value of Node 1 to “3”. Because Module 3 has the active lock on Node 1, the ePLM 200 pushes the transient change at 814, changing the parameter value of Node 1 from “1” to “3”. At 816, Module 1 attempts to push a change to Node 1 (i.e., to change the parameter value to “12”). However, because Module 3 still has the active lock, this change is preempted and stored in the ChangeStore at 818.

At 820, Module 2 requests a lock on Node 1. Because Module 3 is still the highest priority module, it maintains its active lock state. Accordingly, at 822, the ePLM 200 preempts the lock on Module 2. In other words, any changes that are pushed by Module 2 while it is in a preempted lock state, will be stored in the ChangeStore for potential future use.

Module 1 releases its lock on Node 1 at 824. Because Module 1 has a stored preempted change that remains in the ChangeStore, (see step 818, where Module 1 wishes to change the parameter value from “1” to “12”), the ePLM 200 continues to monitor this released preempted change in the ChangeStore, At 828, Module 2 attempts to push a transient change to the Node 1, which would change the parameter value from “1” to “4”. Because Module 3 still has the active lock at this point, the change pushed by Module 2 is stored in the ChangeStore at 830. Module 3 pushes a new transient change at 832, in which it wishes to change the parameter value of Node 1 from “3” to “5”. Because Module 3 has the highest priority and the active lock, this transient change is made by the ePLM 200 at 834, thereby changing the parameter value to “5”. At 836, Module 3 releases its lock on Node 1. As a result, its previously applied transient changes (i.e., changing the parameter value to “5” and “3”) are immediately rolled back, and at 840 the ePLM 200 modifies the parameter value of Node 1 to “2” (as this was the previously stored change made by Module 1).

At 840, the ePLM provides the active lock to Module 2, which is now the highest priority module. Because Module 2 is now active, its previously preempted change (i.e., changing the parameter value of Node 1 to “4”) is pushed by the ePLM 200 at 842. At 844, Module 2 pushes another parameter value change to the ePLM 200, which applies the change at 846, thereby changing the parameter value of Node 1 from “4” to “5”.

At 848, Module 2 releases its lock on Node 1. As a result, the ePLM 200 immediately rolls back the transient changes that Module 2 made to Node 1. In other words, and as seen at 850, the parameter value of Node 1 is changed from “5” to “2”, which previously stored change was made by Module 1. Although Module 1 has released its lock, from the perspective of the ePLM 200, Module 1 has a “released active lock”, and accordingly, the preempted changes made by Module 1 and stored in the ChangeStore will now be applied. Specifically, at 852, the ePLM 200 changes the parameter value of Node 1 from “2” to “12”, which was a previously stored steady state change in the ChangeStore. At 854, the ePLM 200 rolls back the previously stored transient change pushed by Module 1, i.e., changing the parameter value of Node 1 from “12” to “1”. The ePLM 200 pushes the final parameter value to an Operation Support System (OSS) at 856.

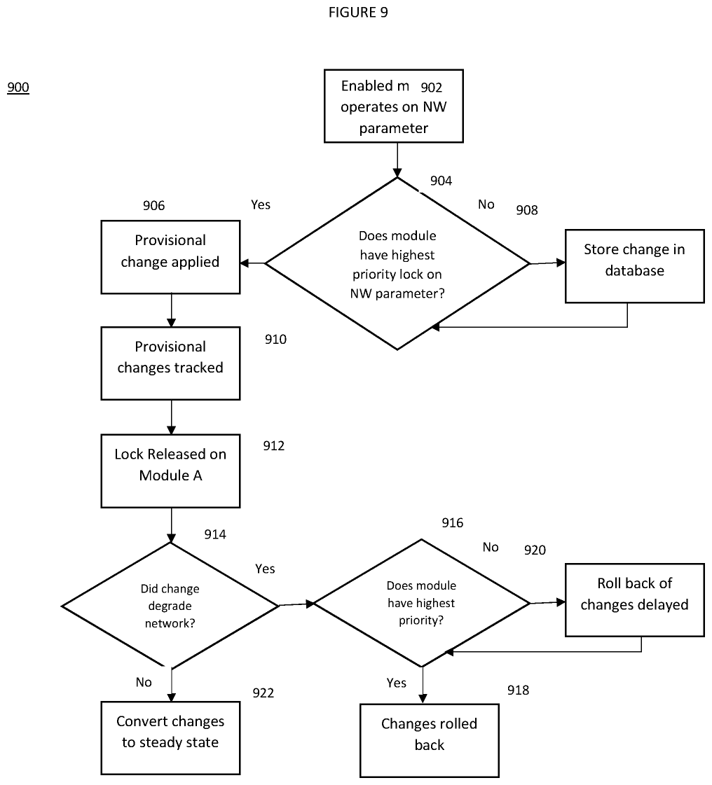

Referring now to FIG. 9, a method 900 is provided for handling provisional changes in accordance with the present disclosure. Specifically, at 902, the enabled module, Module A, operates on a network parameter having an initial configuration. At 904, the ePLM 200 monitors whether the Module A has the highest priority lock on the network parameter. If Module A is the highest priority enabled module currently operating on the network parameter, then at 906, the ePLM 200 allows the provisional change to be made to the network parameter. If Module A is not the highest priority enabled module currently operating on the network parameter, then at 908, the ePLM 200 stores the change in a ChangeStore database or in the memory 204, for example, until Module A becomes the highest priority enabled module with an operational lock configured for making changes to the network parameter. At 910, the ePLM 200 keeps track of the provisional changes that have been made to the network parameter, either in the ChangeStore database or in the memory 204, for example. At 912, the lock on Module A is automatically released, indicating that Module A has completed its operation on the network parameter.

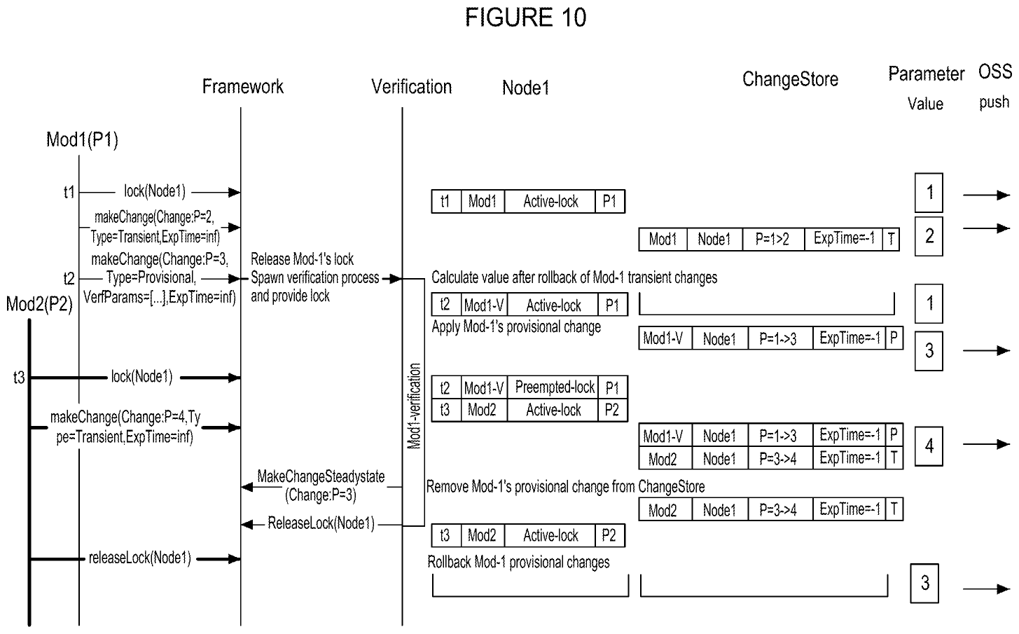

After the lock on Module A has been released (indicating that the Module A has completed its operation on the network parameter, for example), the lock is “transferred” or taken over by the verification function 310. Alternatively, a new lock can be provided to the verification function 310, which corresponds to the lock that was provided to Module A (i.e., it has the same priority and same time-of-issue). If the changes made to the network parameter resulted in a network degradation, the ePLM 200 converts the change a transient change, and roll backs the transient changes made to the network parameter by Module A. Specifically, at 916, the ePLM 200 determines whether the verification function associated with Module A is the highest priority module having a lock on the network parameter. If so, then at 918, the ePLM rolls back the transient changes made to the network parameter, such that the network parameter is restored to its initial configuration. If the verification function associated with Module A is not the highest priority module having a lock on the network parameter, then at 920, the ePLM 200 delays the roll back of transient changes until verification function associated with Module A is the highest priority module having a lock on the network parameter. Alternatively, at 914, if the changes made to the network parameter did not result in a network degradation (i.e., they resulted in the network remaining steady or in a network improvement), the ePLM 200 converts the changes to steady-state changes at 922, maintaining the changes made to the network parameter. A verification function may also be utilized to evaluate provisional changes, which will be described in further detail below with respect to FIG. 10.

FIG. 10 provides a signaling flow diagram 1000 illustrating the verification of provisional changes in accordance with an embodiment of the present disclosure. As briefly described above with reference to FIG. 3, the proposed system 300 can include the verification function 310, which is a common service that may be utilized by all modules to evaluate provisional changes with reference to performance KPIs. Based on the outcome of such an evaluation, the provisional changes may be made steady-state for the network, or rolled back.

Specifically, at 1002, the ePLM 200 provides an active lock to Module 1, which is the highest priority module of the modules currently requesting a lock. Module 1 pushes a transient change to Node 1 at 1004, which the ePLM 200 applies by changing the parameter value from “1” to “2”. At 1006, Module 1 pushes a provisional change, which would change the parameter value to “3”. Because the pushed change is a provisional change, the ePLM 200 releases the lock on Module 1 at 1008, and initiates the verification process by providing the verification function 310 with the lock at 1010. At 1012, the previously applied transient change pushed by the ePLM 200 is rolled back, changing the parameter value of Node 1 back to “1”. At 1014, the verification function 310 applies the provisional change, thereby changing the parameter value of Node 1 from “1” to “3”.

Module 2, which has a higher priority than Module 1, requests and is given an active lock at 1016. As a result, at 1018, the ePLM 200 preempts the verification function lock on Module 1. At 1020, Module 2 pushes a transient change, which is applied by the ePLM 200, changing the parameter value of Node 1 from “3” to “4”. The verification function 310 then evaluates the proposed provisional change pushed by Module 1, and at 1022, determines that the provisional change should be made a steady state change. This decision removes the previously stored provisional change from the ChangeStore. At 1024, the verification function 310 releases its lock on Module 1, and at 1026, the ePLM 200 releases the active lock on Module 2. As a result, at 1028 the ePLM 200 rolls back the transient change made by Module 2, thereby changing the parameter value from “4” to “3”, because the previously indicated provisional change pushed by Module 1 has been made steady state by the verification function. As a result, the ePLM pushes the parameter value of “3” to the OSS at 1030.

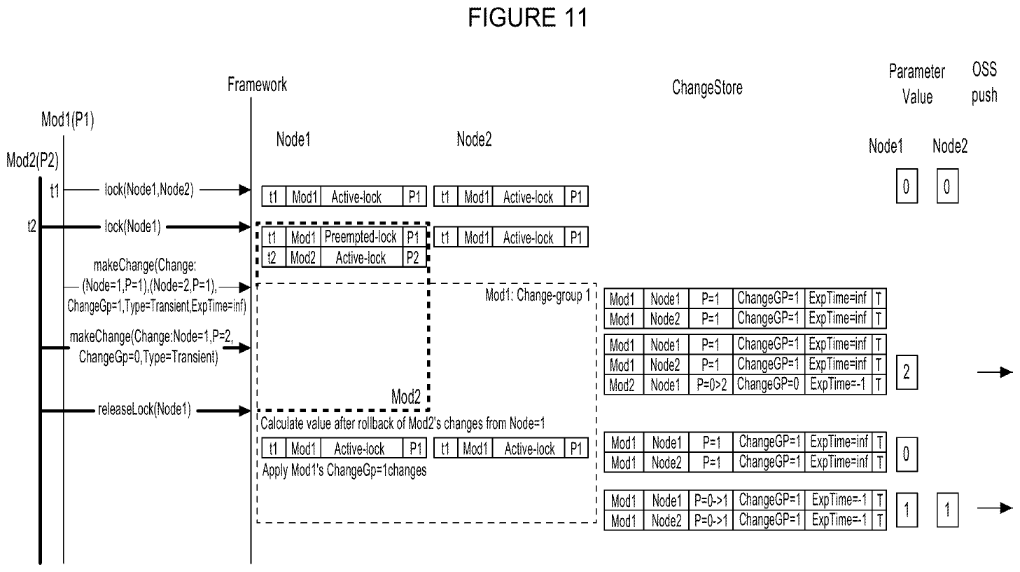

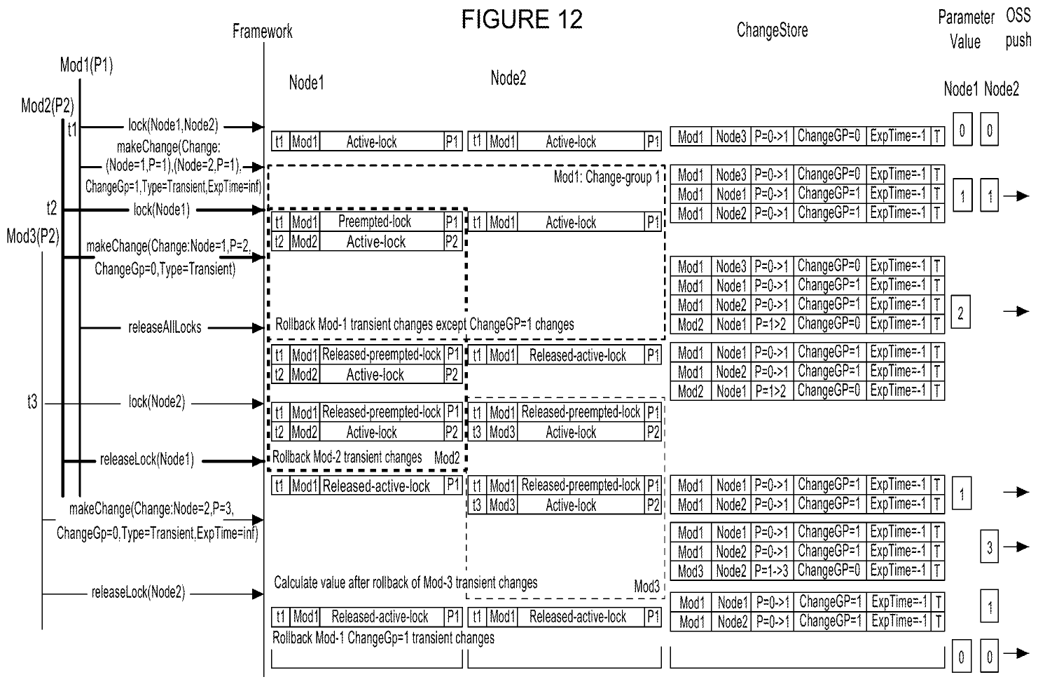

FIGS. 11 and 12 describe the proposed handling of coupled changes or change groups in accordance with an embodiment of the present disclosure. In the present disclosure, coupled changes or a change group is defined as a set of changes, pushed by a module to potentially different objects, which are related to each other and therefore should be managed (applied or rolled-back) together. As will be described in further detail below, a change from a change-group is applied only when the module has an operational lock on all objects of the associated change-object-group and all the changes of the change-group can be applied together. Similarly a change from a change-group can be rolled-back only when the module has a released-active lock on all objects of the associated change-object-group and all the changes of the change-group can be rolled-back together.

For example, consider signaling diagram 1100 in FIG. 11, which identifies Modules 1 and 2, which are configured to operate on Nodes 1 and 2. In the present example, Module 1 has a lower priority than Module 2. At 1102, the ePLM 200 provides Module 1 with an active lock on both Nodes 1 and 2 (N1 and N2, respectively). The parameter values of N1 and N2 are currently set to “0”. Module 2 requests a lock to operate on N1, and because it has a higher priority than Module 1, the ePLM 200 preempts the lock on Module 1 and provides an active lock to Module 2 at 1104. As can be seen from FIG. 11, at this point, Module 1 still has an active lock on N2.

Module 1 pushes a transient change to modify N1 and N2 from “0” to “1” at 1106. However, because Module 1 does not have an active lock on both N1 and N2, the ePLM stores the transient change as a change group in the Change Store. At 1108, Module 2 pushes a transient change to modify N1 from “0” to “2”. Because Module 2 has an active lock on N1, the ePLM 200 applies the change to the parameter vale of N1. At 1110, Module 2 releases its lock on N1. Accordingly, at 1112, Module 1 now has an active lock on both N1 and N2, and the previously stored change group parameter value can be applied to both N1 and N2 at 1114. This results in a parameter value of “1” for both N1 and N2, which value the ePLM 200 pushes to the OSS at 1116.

FIG. 12 illustrates a diagram 1200 for rolling back coupled changes in accordance with the present disclosure. As can be seen in FIG. 12, Modules 1, 2, and 3 are provided and can be configured to operate on Nodes 1 and 2 (N1 and N2, respectively) by the ePLM 200. At 1202, ePLM 200 provides an active lock to Module 1 on N1 and N2. At 1204, Module 1 pushes a transient change to N1 and N2, which is applied by the ePLM 200, changing the parameter values of N1 and N2 from “0” to “1”. Module 2 requests a lock on Node 1 at 1206, and because it has a higher priority than Module 1, the ePLM 200 provides Module 2 with an active lock on N1. Accordingly, at 1208, the lock on Module 1 is preempted by the ePLM 200, and the change group value (i.e, the transient change from “0” to “1”) is stored in the ChangeStore.

At 1210, Module 2 pushes a transient change to N1, requesting a change in parameter value from “1” to “2”. Because Module 2 has an active lock on N1, the ePLM applies the change to N1, changing the parameter value of N1 to “2”. Module 1 releases its locks on N1 (Pre-empted lock) and N2 (Active-lock) at 1212. Since Module 1's applied transient change (on N1 and N2) is a coupled change and it does not have an Active lock on N1, the transient change does not get rolled-back at this time and its transient change and locks on N1 and N2 are still tracked by the ePLM. At 1214, Module 3 requests a lock on N2. The ePLM 200 grants the lock to Module 3, as it is the highest priority module currently requesting a lock on N2. At 1216, Module 2 releases its lock on N1, thus rolling back the transient change made to the parameter value of N1, changing the value of N1 from “2” to “1” at 1218. At 1220, Module 3 pushes a transient change to N2, requesting a change in parameter value from “1” to “3”. Because Module 3 has an active lock on N2, the ePLM 200 applies the change. Module 3 releases its lock on N2 at 1222, which causes the transient changed pushed by the ePLM 200 to be rolled back to its previous configuration. In other words, at 1224, the parameter value of N2 is rolled back from “3” to “1”. At this time Module 1 once again has an active lock on both N1 and N2 and its change-group values are rolled-back to their original value of “0”. At 1228, the ePLM 200 pushes the “0” values of N1 and N2 to the OSS.

The present enhanced priority and locking mechanism provides a framework in which modules are enabled to operate on objects or network parameters based on their priority. When a number of modules request a lock for operating on a network parameter, the lock is provided to the highest priority of the requesting modules. Such a methodology prevents lower priority modules from obtaining a lock and from operating on the network parameter. The present ePLM is also configured to handle changes made by modules that have been preempted or delayed due to a superseding request made by a higher priority module. The present ePLM is also configured to provide a common framework/methodology for rolling back transient changes made by the modules. As a result of the ePLM 200, the network can be left in a trackable state at the end of module operation. Further, the present ePLM 200 provides a framework for automatic verification of changes. It also provides a framework for handling changes that need to be managed together. While the above-identified ePLM has been described as being part of a SON, it is contemplated that the ePLM may be configured to operate in any other type of network management environment.

Embodiments of the present disclosure may be implemented in software (executed by one or more processors), hardware (e.g., an application specific integrated circuit), or a combination of software and hardware. In an example embodiment, the software (e.g., application logic, an instruction set) is maintained on any one of various conventional non-transitory computer-readable media. In the context of this document, a “non-transitory computer-readable medium” may be any media or means that can contain, store, communicate, propagate or transport the instructions for use by or in connection with an instruction execution system, apparatus, or device, such as a computer. A non-transitory computer-readable medium may comprise a computer-readable storage medium (e.g., memory or other device) that may be any media or means that can contain or store the instructions for use by or in connection with an instruction execution system, apparatus, or device, such as a computer. As such, the present disclosure can include a computer program product comprising a computer-readable storage medium bearing computer program code embodied therein for use with a computer, the computer program code comprising code for performing any of the methods and variations thereof as previously described. Further, the present disclosure also includes an apparatus which comprises one or more processors, and one or more memories including computer program code, wherein the one or more memories and the computer program code are configured, with the one or more processors, to cause the apparatus to perform any of the methods and variations thereof as previously described.

If desired, the different functions discussed herein may be performed in a different order and/or concurrently with each other. Furthermore, if desired, one or more of the above-described functions may be optional or may be combined.

Although various aspects of the disclosure are set out in the independent claims, other aspects of the disclosure comprise other combinations of features from the described embodiments and/or the dependent claims with the features of the independent claims, and not solely the combinations explicitly set out in the claims.

It is also noted herein that while the above describes example embodiments of the disclosure, these descriptions should not be viewed in a limiting sense. Rather, there are several variations and modifications which may be made without departing from the scope of the present disclosure as defined in the appended claims.

One having ordinary skill in the art will readily understand that the disclosure as discussed above may be practiced with steps in a different order, and/or with hardware elements in configurations which are different than those which are disclosed. Therefore, although the disclosure has been described based upon these preferred embodiments, it would be apparent to those of skill in the art that certain modifications, variations, and alternative constructions would be apparent, while remaining within the spirit and scope of the invention. In order to determine the metes and bounds of the disclosure, therefore, reference should be made to the appended claims.

The following abbreviations that may be found in the specification and/or the drawing figures are defined as follows:
ANR Automatic Neighbor Relation
BTS Base Transceiver Station
COC Cell Outage Compensation
eNB Evolved Node B
ePLM Enhanced Priority Locking Mechanism
ER Event Response
HO Handover
LB Load Balancing
NI Network Improvement
PLM Priority Locking Mechanism
RNC Radio Network Controller
SE Special Events
SON Self Organizing Network

1.-25. (canceled)

26. A method for coordinating execution of functions within a self-organizing network, the network including a plurality of network parameters, a controller, a locking mechanism having a processor and a memory and being in communication with the controller, and a plurality of modules configured for operating on the network parameters, each of the plurality of modules being assigned a priority level; the method including:
receiving a request from at least one of the modules for a lock;
providing the lock to the module having a highest priority level relative to the plurality of modules that requested a lock;
receiving a request at the locking mechanism from the module having the lock;
enabling the module having the lock to make changes to a network parameter of the plurality of network parameters, wherein the changes include at least one of steady-state changes, transient changes, and provisional changes; and
releasing the lock on the enabled module when the enabled module has completed its operation on the network parameter.

27. The method of claim 26, further comprising monitoring transient changes made to the network parameter by the enabled module and rolling back the transient changes made to the network parameter by the enabled module.

28. The method of claim 26 wherein the lock on the enabled module is released when the locking mechanism has determined that the enabled module has completed its operation on the network parameter.

29. The method of claim 26 further including:
receiving a request at the locking mechanism from a module having a lower priority than the highest priority level module, wherein the lower priority module requests to operate on a network parameter of the plurality of network parameters; and
delaying the lower priority module from operating on the network parameter.

30. The method of claim 29 wherein the highest priority level module is configured to delay the lower priority module from operating on the network parameter.

31. The method of claim 29, further including:
at the locking mechanism, storing the received request from the delayed lower priority module; and
enabling the lower priority module to operate on the network parameter after the lock on the enabled module has been released.

32. The method of claim 26 further including:
receiving a request for a lock from a module having a higher priority than the enabled module;
pre-empting the enabled module from further operation on the network parameter;
providing the lock to the module having a higher priority than the enabled module;
enabling operation of the module having a higher priority than the enabled module; and
when the module having a higher priority than the enabled module has completed its operation, permitting the enabled module to complete its operation.

33. The method of claim 26, further including:
receiving a request for a lock from a module having a higher priority than the enabled module;
pre-empting the enabled module from further operation on the network parameter;
storing a change value of the network parameter based on the operation by the enabled module;
providing the lock to the module having a higher priority than the enabled module;
enabling operation of the module having a higher priority than the enabled module; and
when the module having a higher priority than the enabled module has completed its operation, restoring the change value of the network parameter based on the operation by the enabled module.

34. The method of claim 26 further including:
providing a lock to the module having a next highest priority level relative to the plurality of modules; and
enabling the next highest priority level module to operate on a corresponding network parameter of the plurality of network parameters;

35. The method of claim 26 further including:
repeating the providing, enabling, monitoring, releasing, and rolling back on the remaining modules in order of their respective priority levels.

36. The method of claim 26 further including:
pre-empting the highest priority level module from operating on a corresponding network parameter if a request from a new priority module with an even higher priority level is detected by the locking mechanism.

37. The method of claim 26 further including:
sending a report of the changes made to the network parameter to a verification server in the network; and
at the verification server, determining whether to maintain the changes made to the network parameter.

38. A locking mechanism in a communications network including a plurality of network parameters and a plurality of modules configured for operating on the network parameters, each of the modules being assigned a corresponding priority level, the locking mechanism comprising:
a processor; and
a memory;
wherein the locking mechanism is configured to:
detect that at least one module of the plurality of modules has attempted to initiate a change to a network parameter;
provide a lock to the highest priority detected module that has attempted to initiate a change to a network parameter;
enable the highest priority detected module to make changes to the network parameter, wherein the changes include at least one of steady-state changes, transient changes, and provisional changes; and
release the lock on the enabled module when the locking mechanism has determined that the enabled module has completed its operation on the network parameter.

39. The locking mechanism of claim 38 wherein the locking mechanism is further configured to
roll back the transient changes made to the network parameter by the enabled module.

40. The locking mechanism of claim 38 wherein the locking mechanism is further configured to:
delay providing a lock to the detected module if the detected module has a lower priority than a previously detected higher priority module attempting to initiate a change to a corresponding network parameter.

41. The locking mechanism of claim 38 wherein the locking mechanism is further configured to:
provide a lock to the lower priority detected module when the previously detected higher priority module has completed its operation on the corresponding network parameter.

42. A system including:
a SON controller;
a plurality of network parameters configured for operating within the system;
a module engine including a plurality of modules and a locking mechanism configured for managing the plurality of modules;
wherein the locking mechanism is configured to, based on a priority level assigned to each of the plurality of modules:
provide a lock to the module having a highest priority level relative to the plurality of modules;
receive a request from the module having the highest priority level;
enable the module having the highest priority level to operate on a network parameter of the plurality of network parameters;
monitor changes made to the network parameter by the enabled module, wherein the changes include at least one of steady-state changes, transient changes, and provisional changes;
release the lock on the enabled module when the locking mechanism has determined that the enabled module has completed its operation on the network parameter; and
roll back the transient changes made to the network parameter by the enabled module.

43. The system of claim 42 wherein the enabled module is configured to release its lock upon completion of the operation on the network parameter.

44. The system of claim 42 wherein the locking mechanism is further configured to provide a lock to a next highest priority detected module when the previously detected highest priority module has completed its operation on the corresponding network parameter.

45. The system of claim 42 wherein the locking mechanism is further configured to preempt a lock to the requesting module if the requesting module has a lower priority than a newly detected higher priority module attempting to initiate a change to a corresponding network parameter.
